(19) United States
(12) Patent Application Publication
(10) Pub. No.: US 2007/0082735 A1
(43) Pub. Date: Apr. 12, 2007

(54) Gear box joystick

(76) Inventor: David Bell, Mullica Hill, NJ (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/248,520

(22) Filed: Oct. 12, 2005

(51) Int. Cl. A63F 13/00

(52) U.S. Cl. 463/38

(57) ABSTRACT

The present gearshift addresses these problems. The shifter has a ball and socket joint; an upper elongated post and pin extending from the ball; and a switchplate that carries several switches. The switches communicate with a central processing unit that receives a signal upon activation of said switches. Movement of the elongated post causes movement of the ball within the socket, which in turn causes movement of the pin, and further, the pin contacts the switches to send the signal to the central processing unit that corresponds to a gearshift in the video game.

### FIELD OF INVENTION

The field of invention is video game controllers, and in particular shifters for use in video games.

### BACKGROUND

Video games have become so popular that the recent release of one game “Halo 2,” grossed more money in its opening twenty-four hours than the highest grossing opening for a movie (Spiderman 2) made in its entire opening weekend. And research shows that video games have long since moved from the sole domain of children to become the past-times of adults.

This trend in video games parallels the impressive rise in the popularity of automobile racing. Long thought the exclusive interest of gearheads and car-lovers, automobile racing is arguably the most popular sport in the United States. More women watch NASCAR than any other sport, and NASCAR's television ratings rival the National Football League.

The dual rise in popularity in both video games and automobile racing has yielded a multitude of automobile racing games. The best of these games take advantage of interconnected networks that allow people to race against each other, sometimes just for a single race and others in competitive video game racing leagues.

The video games themselves are all different variants of automobile racing, and the interface between the player (driver) and the game is also varied. A driver can operate his car using a keyboard, mouse, joystick, thumbpad, or combinations thereof. But the more dedicated drivers use steering wheels and pedals, and some even set up driving cockpits to better simulate the driving experience.

One of the failings of the interfaces in driving games is a realistic gear shifter. Current gearshifters are either too “plastic” feeling, and thus feel more like a toy than a car, or the higher end gear shifters are large, heavy, and/or of poor design. Thus, a need exists for a vide game gearshift with a more realistic feel, which is both reliable and affordable.

### SUMMARY

The present gearshift addresses these problems. The shifter has a ball and socket joint; an upper elongated post and pin extending from the ball; and a switchplate that carries several switches. The switches communicate with a central processing unit that receives a signal upon activation of said switches. Movement of the elongated post causes movement of the ball within the socket, which in turn causes movement of the pin, and further, the pin contacts the switches to send the signal to the central processing unit that corresponds to a gearshift in the video game.

### BRIEF DESCRIPTION OF THE DRAWING(S)

FIG. 1 shows a partially cutaway isometric view of the inventive gear shifter.

FIG. 2 shows an enlarged partially cutaway isometric view of the inventive gear shifter of FIG. 1.

FIGS. 3-3D are partially cutaway views of the inventive gear shifter of FIG. 1.

FIGS. 4 and 5 are a partially cutaway isometric views of the inventive gear shifter of FIG. 1.

FIG. 6 is an isometric view of a second embodiment of the inventive gear shifter.

FIG. 6A is an elevation view of a second embodiment of the inventive gear shifter.

FIG. 6B is an exploded isometric view of a second embodiment of the inventive gear shifter.

FIG. 7 is a cross sectional elevation view of the gear shifter shown in FIG. 6.

FIG. 8 is a cross sectional side view of the gear shifter shown in FIG. 6.

FIGS. 9-11 are isometric, top, and elevation views of the gate used with the inventive gear shifter.

FIG. 10A is a top view of an alternate embodiment of the gate shown in FIGS. 9-11.

FIG. 12 is an isometric view of a third embodiment of the inventive gear shifter.

FIGS. 13 and 14 are partially cutaway isometric views of a fourth embodiment of the inventive gear shifter.

FIGS. 15-18 are side and elevation views of the joint used with the gear shifter of FIGS. 13 and 14.

### DETAILED DESCRIPTION OF THE PREFERRED EMBODIMENT(S)

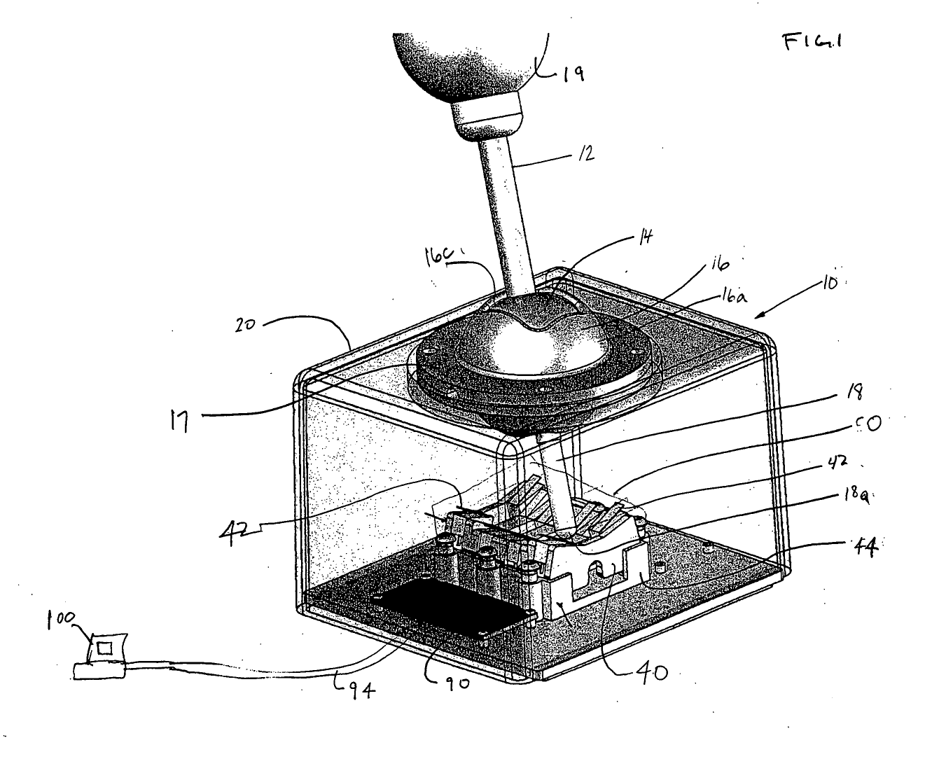

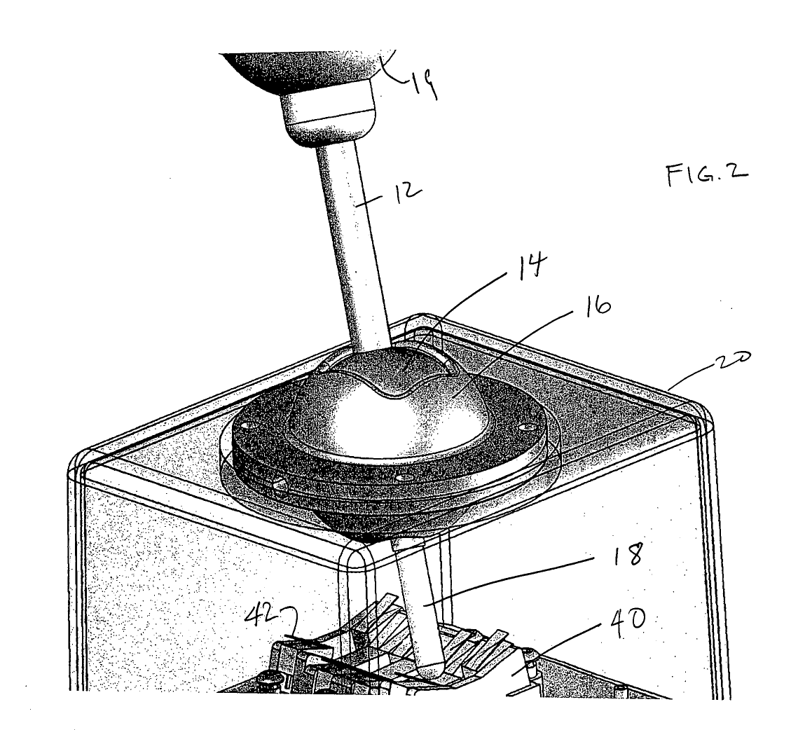

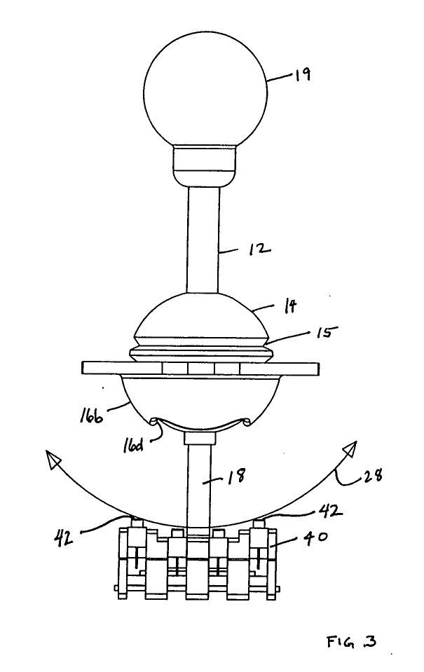

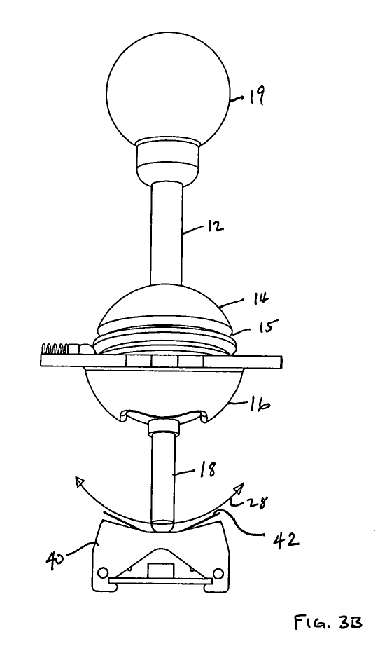

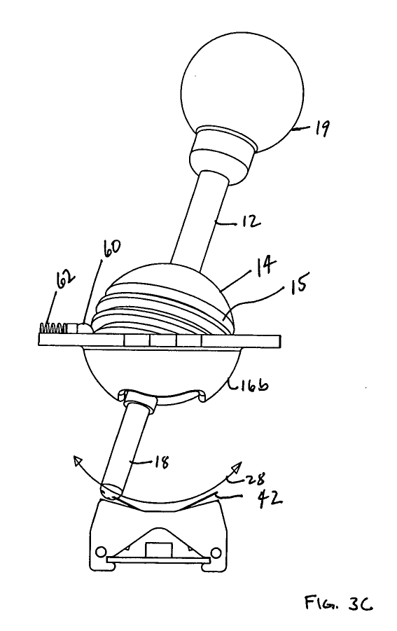

FIGS. 1-5 show a gearshift 10 for use with video games. The gearshift 10 has a shift knob 19 mounted on a shift post 12 that simulates the look of an automobile gear shift. The gearshift 10 has a housing 20 from which the shifter post 12 emerges.

A two part socket 16 engages the top of the housing 20, with the top portion 16a of the socket 16 extending from the housing 20. The socket 16 is generally spherical, and as is currently preferred, the socket 16 has a flange 17 that engages the housing 20.

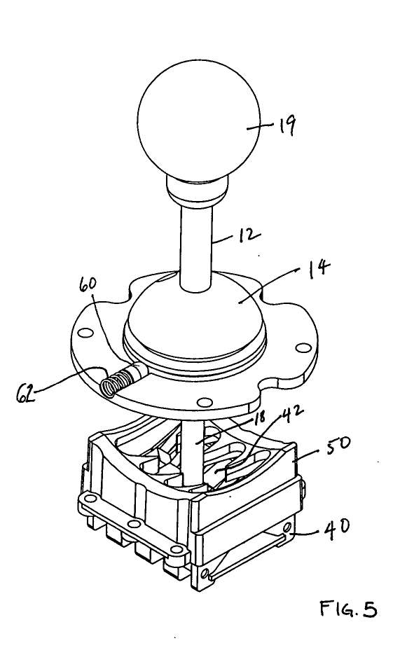

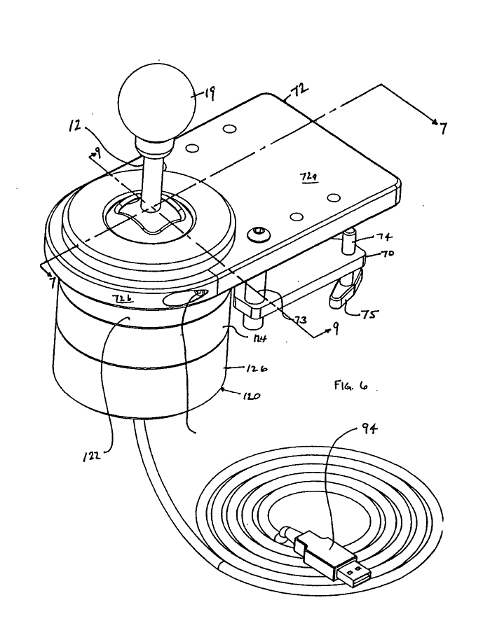

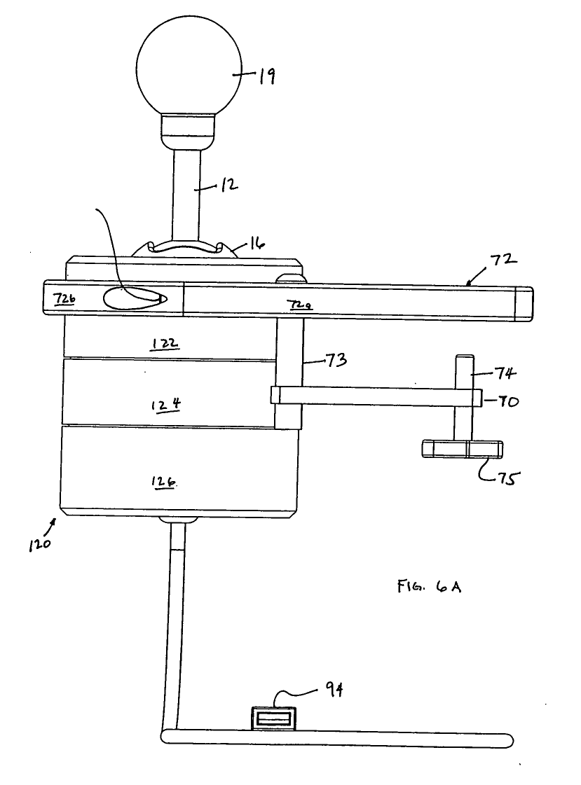

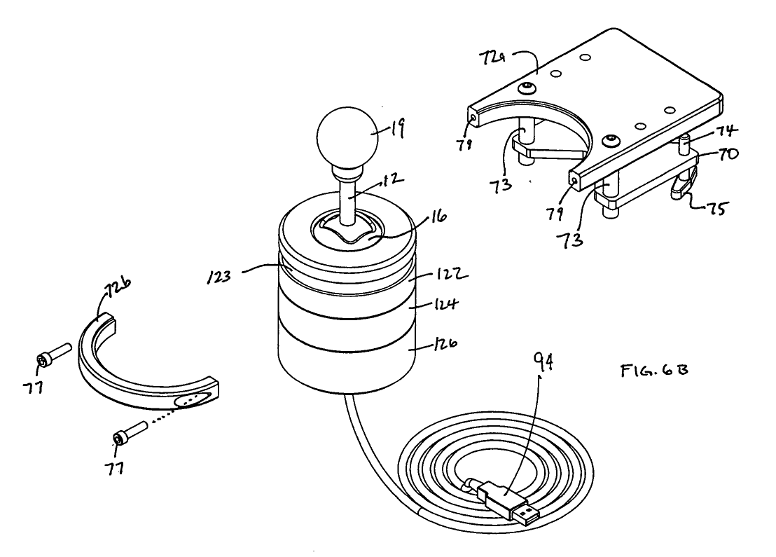

The socket 16 holds a ball 14 that rotates freely therein in a ball-and-socket joint. The socket 16 has two openings 16c and 16d formed in the top portion 16a and bottom portion 16b of the socket respectively, through which the shift post 12 and a pin 18 extend on substantially opposite sides of the ball 14. This is best seen in the cross section shown in FIGS. 8 and 9 which show the post 12 and pin 18 engaged within a sleeve 22 inside the ball 14, preferably in a threaded fit, although an adhesive or interference fit could be adequate. Further, it should be noted that for easy assembly and maintenance, the ball 14 is preferably made of two semispheres 14a, 14b as shown in FIGS. 7 and 8 that are connected by threads or other bonding in the area 14c, although a single piece construction is also acceptable.

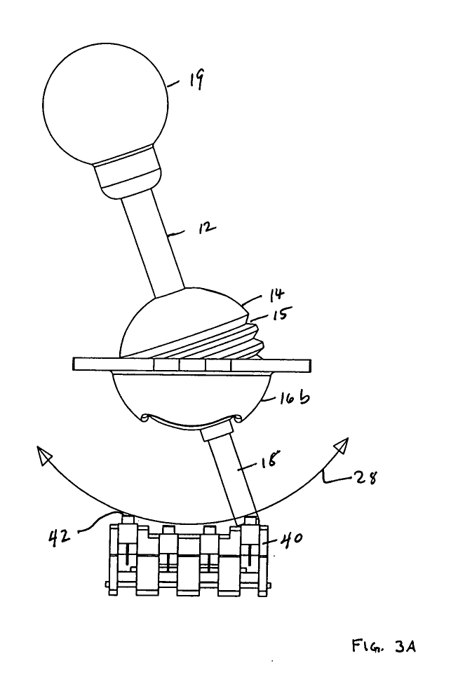

Due to interference between the post 12 and pin 18 with the boundaries of the openings 16c, 16d, the ball 14's movement within the socket 16 is limited to a certain sweep of motion. This is best seen in FIG. 3, which shows the pin's tip 18a that travels along a spherical arc 28.

During the tip 18's sweep through this spherical arc 28, it contacts switches 42 mounted on a switchplate 40, preferably located in, or parallel to, the spherical arc 28 such that movement of the tip 18a within the arc 28 contacts the switches 42. The positioning of the switches 42 in proximity to the spherical arc 28 is critical to their activation; if the switches 42 are too close to the arc, the tip 18a may interfere and damage the switches 42—if the tip 18a is too far from the switches 42, it will not activate them.

Contact between the tip 18a and a microswitch or switch 42 activates the switch 42 and sends a signal from a PC board 90, preferably through a USB connection 94, to the CPU 100, where the switch 42 activation registers as a gear shift in the video game.

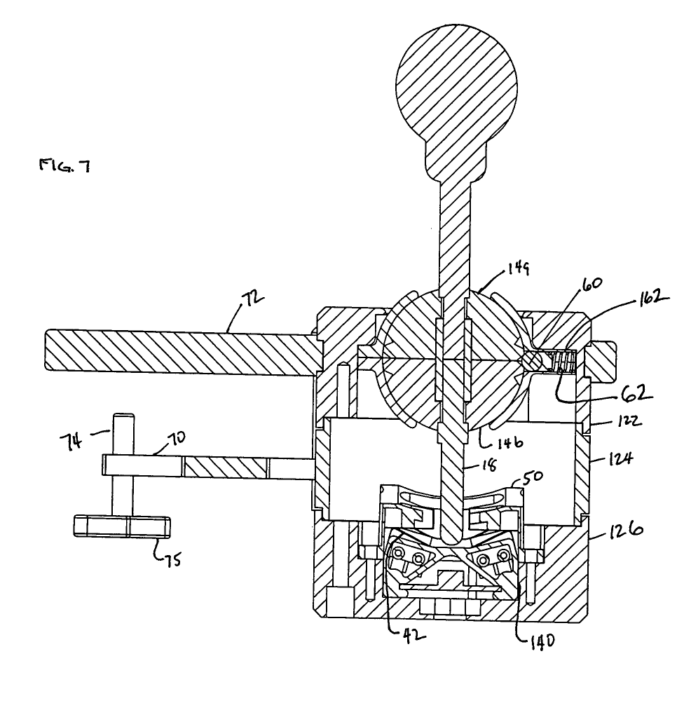

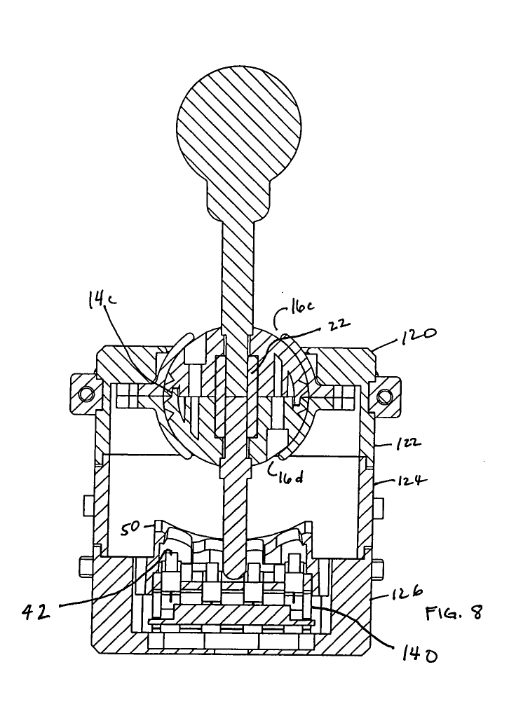

Since most driving video games require the driver to properly progress through gears, the movement of the pin 18 is limited by a gate 50 mounted above the switches 42. The gate 50, which is best seen in FIGS. 9-11, has an open channel 42 through which the pin 18 passes, that acts to limit the motion of the pin 18. To better simulate real gear-shifting, the gate 50 has switch engaging points 54, which are stopping points corresponding to the switches 42—when the tip 18a moves to these positions, it activates the switch 42 in the position aligned with the switch engaging point 54. The gate 50 could have an open channel 52 with a repeating and preferred Z-like pattern as shown in FIGS. 9-11, or an H-like pattern 350 (with channel 352 and engaging points 354) as shown in FIG. 10A. The Z pattern provides a point to point shift that encourages the driver to shift quickly and confidently between gears, and discourages misshifts.

The switches 42, which have been mentioned in some detail already, are mounted to a switchplate 40 with a geometry complementary to the spherical arc 28 traced by the tip 18a. The geometry of the switchplate 40 may be such that it forms a parallel spherical arc. The switchplate 40 is mounted to a switch mount 44 attached to the housing 20. The switches 42 are electrically connected to the PC Board 102, which sends a signal to the CPU 100 upon activation of a switch 42. The manner of transmitting the signal could be via USB, Firewire, serial, wireless, or other connection, with USB being presently preferred due to its widespread use.

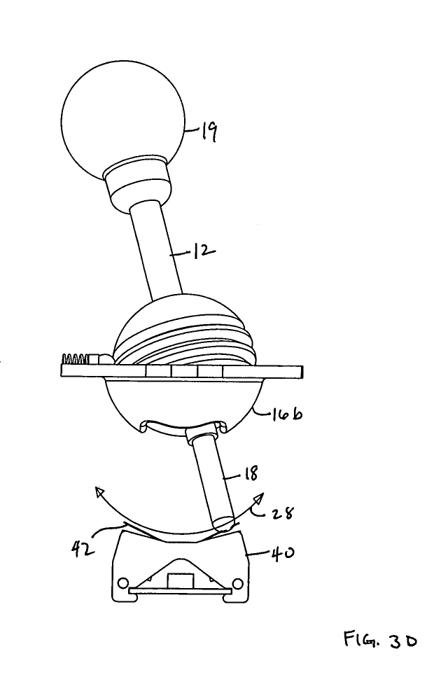

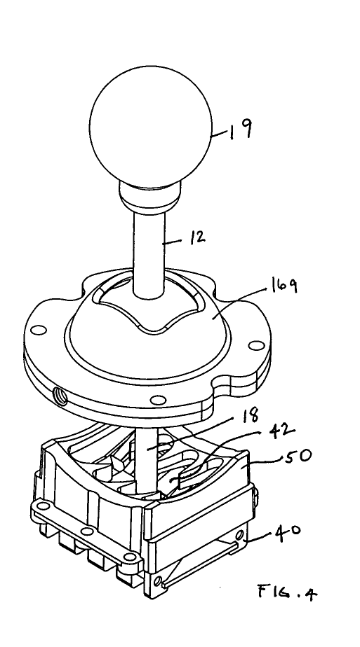

One problem with known video game gearshifts 10 is that they move easily and feel, for lack of a better adjective “plastic-like,” which makes them wanting of realism. The ball 14 and socket 16 joint comprises an additional feature which helps with the realistic feel of the gearshift 10. A spring-biased bearing 60 housed within a channel 17a (in the embodiment shown in FIGS. 1-5) or the housing 120 (for the embodiment shown in FIGS. 6-8) presses against the ball 14. The spring 62 exerts enough force on the bearing 60 that it inhibits the ball 14's movement when the driver moves the shift knob 19. Further adding to the realistic feel-the “clunk” of a real gear's engagement, the ball moves between concave features 15 on the surface of the ball 14, these concave features could be detents or as shown and preferred, grooves 15.

When aligned within a groove 15, the bearing 60 presses therein, and movement to an adjacent groove 15 momentarily presses the bearing 60 against the spring 62, and upon realignment with the adjacent groove 15, the bearing 60 presses into that adjacent groove. The movement of the bearing between the grooves provides a satisfying “clunk” that simulates the feel of a real gearshift.

Properly aligned detents on the surface of the ball 14 could be located such that the only places where the bearing 60 engages the ball 14 are in areas corresponding to where the tip 18a engages a switch.

The housing 120 could also assume the alternate embodiment shown in FIGS. 6-8 in which the housing 120 is generally cylindrical. The housing 120 comprises three separate portions: top 122, middle 124, and bottom 126. The top portion 122 holds the socket 16 therein. It also has a hole 162 in which the spring 62 is held. The top portion 122 also engages the mounting plate 71, as will be discussed in more detail below. The middle portion 124 engages the top portion via threads; interference fit, adhesive or other connection in the area 123, and similarly engages the bottom portion 126 in the area 125. The bottom portion houses the switch mount 144, switch plate, 140, switches 140, and gate 50—all of which operate similar to the configuration shown in FIGS. 1-5. It can be seen from this multipiece housing 120 that maintenance and assembly of the multi piece switch mount 144, switch plate, 140, switches 140, and gate 50 is easier, as all of these pieces are more easily accessed in this embodiment.

The embodiment shown in FIGS, 6-8 shows a mounting assembly comprising a mounting plate 72 with a bracket 70 attached thereto. The mounting plate 72 comprises two pieces, 72a and 72b, that engage a groove 123 on the top portion 122 of the housing 120, as best seen in FIG. 6B. Due to the housing 120's cylindrical shape, the bracket 72 can be mounted at any position around the circumference of the groove 123. The bracket 72 pieces 72a and 72b are secured to each other using screws 77, which pass through piece 72b into corresponding holes 79.

The mounting bracket is slidably attached to a post 73 which is fixed at one end to the mounting plate 72. In use, the mounting plate 72 is placed over a stationary object, while the bracket is placed under the same object. Turning screw 74 using knob 75 clamps the object between the screw 74 and the plate 72. This mounting assembly could also be used with the embodiment of FIGS. 1-5.

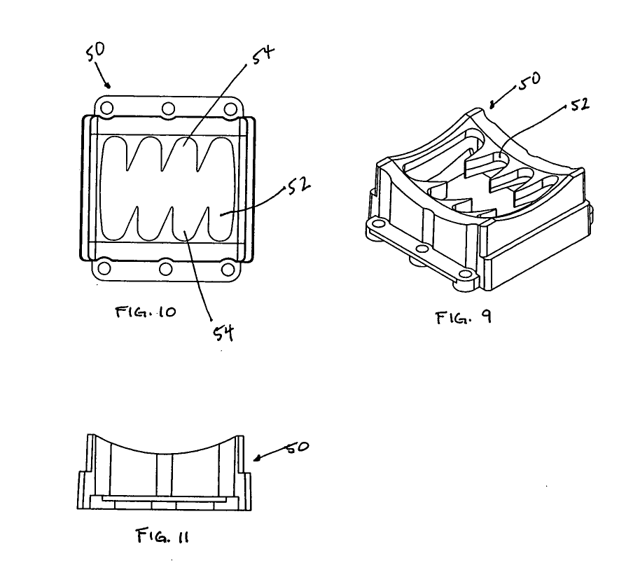

As shown in FIG. 12, a rubber, plastic, or leather boot 13 could engage the shifter post and housing 20 or socket 16 to increase the realistic look of the gearshift 10 and protect the gearshift 10 from intrusion of foreign objects.

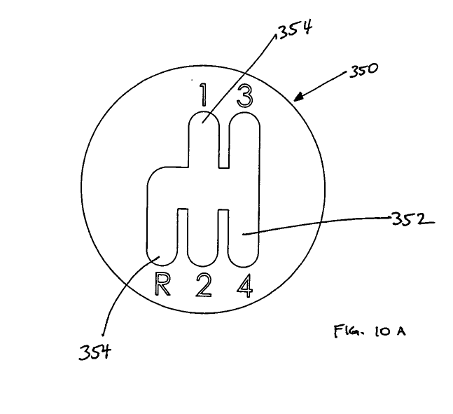

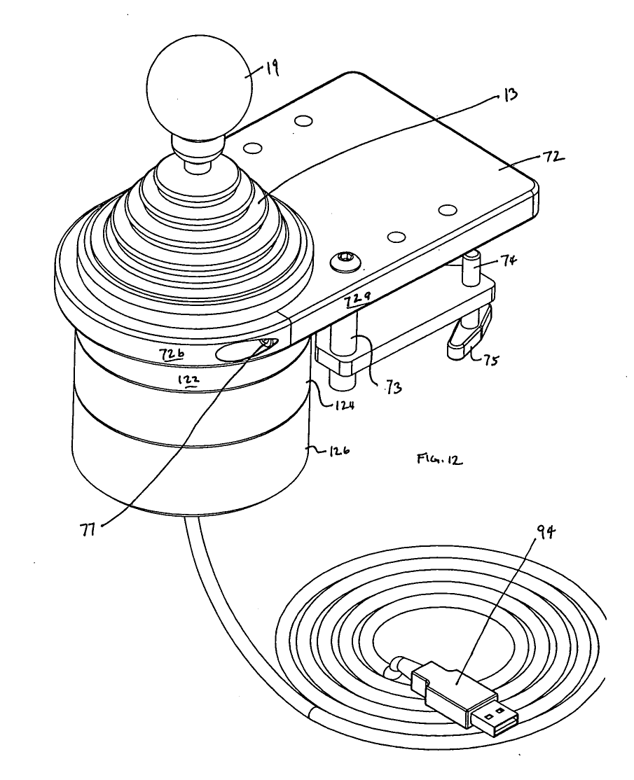

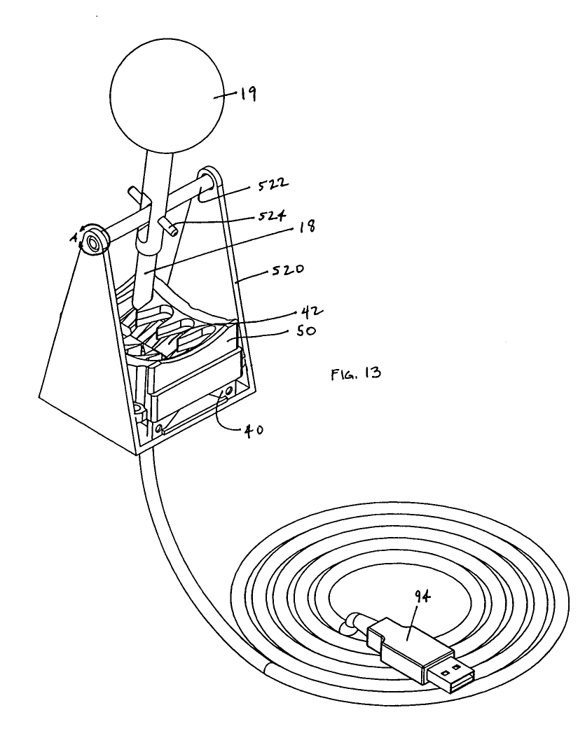

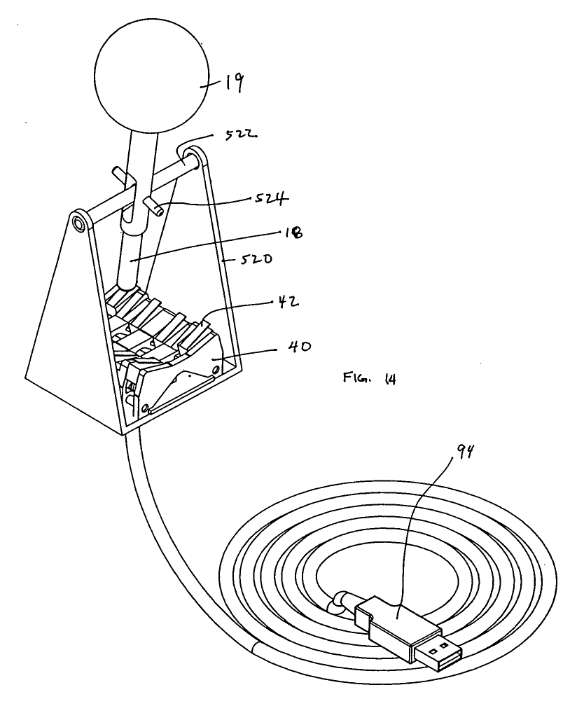

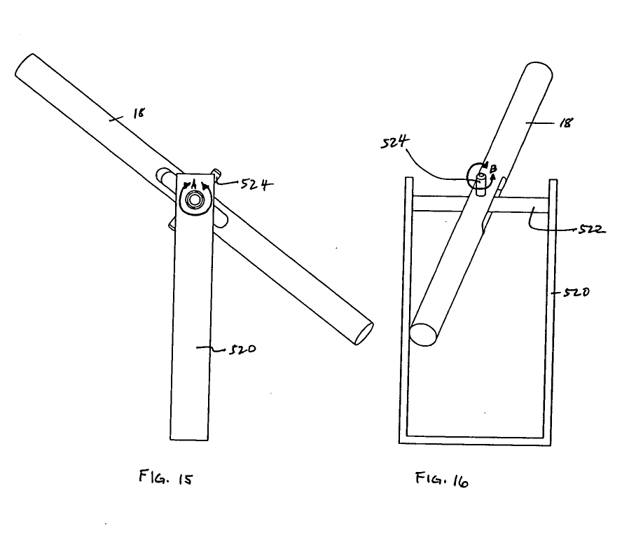

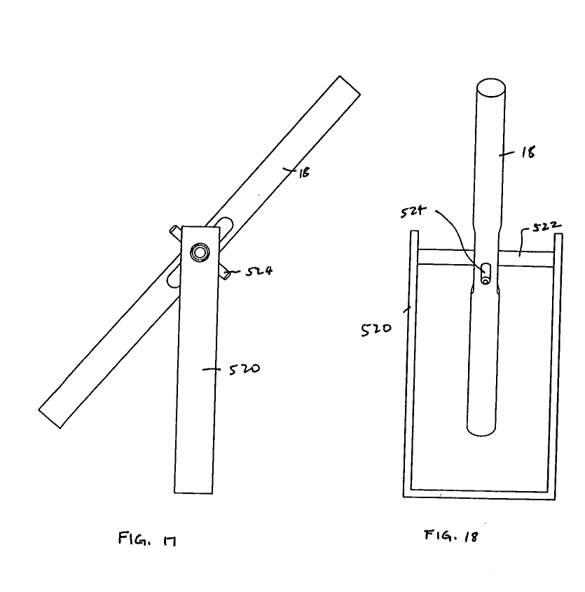

FIGS. 13-18 show an alternate embodiment of the inventive gearshift in which a universal joint is substituted for the ball and socketjoint discussed above. This embodiment comprises a sub-housing 520 that could be contained within some larger housing such as the housings 20 and 120, such that the shift knob 19 extends from this larger housing.

The sub-housing 520 holds a first axle 522 at either of its ends, and allows the axle 522 to rotate freely in the direction A. The axle 522 has a hole therethrough (not visible) through which passes a second axle 524. The knob 19 and tip 18 rotate about this second axle in the direction B. Since the tip 18 can move about directions A and B, the tip moves freely within the gate 50 to engage switches 42, as previously discussed.

What is claimed is:

1. A shifter for use in video games comprising:
a ball and socket joint;
an upper elongated post and pin extending from the ball;
a switchplate comprising a plurality of switches; said switches in communication with a central processing unit that receives a signal upon activation of said switches;
wherein movement of the elongated post causes movement of the ball within the socket, which in turn causes movement of the pin; and
wherein the pin contacts the switches to send the signal to the central processing unit.

2. The shifter of claim 1, further comprising a gate with an open channel therethough, through which the pin extends.

3. The shifter of claim 2, wherein the movement of the pin is confined within the open channel.

4. The shifter of claim 3, wherein the open channel has switch engaging points aligned with the switches.

5. The shifter of claim 4, wherein when the pin is aligned with the switch engaging points, the pin activates a switch.

6. The shifter of claim 1, wherein the pin has a tip that travels along a first spherical arc.

7. The shifter of claim 6, wherein the switches are located along a second spherical arc 28 parallel to the first spherical arc.

8. The shifter of claim 1, wherein the socket is engaged with a housing that houses the switchplate, switches, and pin.

9. The shifter of claim 1, wherein a spring-biased bearing engages the ball.

10. The shifter of claim 9, wherein a spring that biases the spring-biased bearing is contained within a housing that houses the switchplate, switches, and pin, and the bearing extends through the socket.

11. The shifter of claim 10, wherein the bearing engages concave features on a surface of the ball.

12. The shifter of claim 11, wherein the concave features comprise concave detents.

13. The shifter of claim 11, wherein the concave features comprise more than one concentric groove.

14. The shifter of claim 11, wherein when the spring is engaged within the concave feature, the ball is discouraged from movement within the socket except when acted upon.

15. The shifter of claim 9, wherein the socket comprises flanges that engage a housing that houses the switchplate, switches, and pin, and wherein the flanges house a spring that biases the spring-biased bearing.

16. The shifter of claim 1, wherein the ball 14 comprises two joined semispherical portions.

17. The shifter of claim 16, further comprising a sleeve within the ball, wherein the sleeve engages the post and the pin.

18. The shifter of claim 1, further comprising a multiple portions, including at least a first portion that houses a portion of the socket, and a second portion that houses the switchplate, switches, and pin.

19. The shifter of claim 1, further comprising a mounting bracket for mounting the shifter to an object.

20. The shifter of claim 19, further comprising a housing that houses the switchplate, switches, and pin, and wherein the mounting bracket engages the housing.

21. The shifter of claim 20, further comprising a mounting plate located substantially parallel to the mounting bracket, the mounting bracket having a mounting screw extending therethrough that clamps an object between the mounting plate and the mounting screw.

22. The shifter of claim 21, wherein the mounting bracket comprises two pieces, each of which engages a groove on the housing.

23. The shifter of claim 22, wherein the housing is cylindrically shaped and the bracket can be rotated thereabout within the groove on the housing.

24. The shifter of claim 10, wherein the housing comprises more than one cylindrical portion engaged to one another to form the housing.

25. A shifter for use in video games comprising:
a universal joint;
an upper elongated post and pin extending from the ball;
a switchplate comprising a plurality of switches; said switches in communication with a central processing unit that receives a signal upon activation of said switches;
wherein movement of the elongated post causes movement of the universal joint, which in turn causes movement of the pin; and
wherein the pin contacts the switches to send the signal to the central processing unit.
